(19) United States
(12) Patent Application Publication
(10) Pub. No.: US 2025/0111030 A1
(43) Pub. Date: Apr. 3, 2025

(54) UNIVERSAL LOGOUT AND SINGLE LOGOUT TECHNIQUES

(71) Applicant: OKTA, INC., SAN FRANCISCO, CA (US)

(72) Inventors: Bjorn Hamel, San Francisco, CA (US); Lars Kristian, San Francisco, CA (US); Bryant Ng, San Francisco, CA (US); Srinivasa Nagandla, Fremont, CA (US); Moushmi Banerjee, Cupertino, CA (US); Antonio Ruberto, San Francisco, CA (US); Chaitrali Gharat, San Francisco, CA (US); Karl McGuinness, Oakland, CA (US); Vishwa Srikaanth, San Francisco, CA (US); Nickolas Gamb, San Francisco, CA (US)

(21) Appl. No.: 18/903,388

(22) Filed: Oct. 1, 2024

Related U.S. Application Data
(60) Provisional application No. 63/587,433, filed on Oct. 2, 2023.

(51) Int. Cl. G06F 21/41

(52) U.S. Cl. CPC G06F 21/41

(57) ABSTRACT

A method of identity management is described. The method may include receiving a request to terminate two or more sessions between a user of an identity management system and two or more respective applications that are accessible via the identity management system. The request may include information associated with the user, information associated with the two or more sessions, or both. The method may further include receiving, via an endpoint associated with a tenant of the identity management system, a set of application programming interface (API) credentials that are usable to communicate with the two or more applications via two or more respective APIs. The method further includes transmitting, via the two or more APIs, respective API calls to terminate the two or more sessions between the user and the two or more applications in accordance with a universal logout (ULO) operation or a single logout (SLO) operation.

### CROSS REFERENCE

The present Application for Patent claims the benefit of U.S. Patent Application No. 63/587,433 by Hamel et al., entitled “UNIVERSAL LOGOUT AND SINGLE LOGOUT TECHNIQUES,” filed Oct. 2, 2023, assigned to the assignee hereof.

### FIELD OF TECHNOLOGY

The present disclosure relates generally to identity management, and more specifically to universal logout (ULO) and single logout (SLO) techniques.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### BACKGROUND

An identity management system may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

### SUMMARY

A method is described. The method may include: receiving a request to terminate a set of sessions between a user of an identity management system and a respective set of applications that are accessible via the identity management system, the request including information associated with the user, information associated with the set of sessions, or both; receiving, via an endpoint associated with a tenant of the identity management system, a set of application programming interface (API) credentials that are usable to communicate with the respective set of applications via a respective set of APIs; transmitting, via the respective set of APIs, a respective set of API calls to terminate the set of sessions between the user and the respective set of applications in accordance with a universal logout (ULO) operation or a single logout (SLO) operation, the respective set of API calls including the set of API credentials, the information associated with the user, the information associated with the set of sessions, or any combination thereof; and outputting, to an observability log maintained by the identity management system, metadata associated with a result of the ULO operation or the SLO operation.

An apparatus is described. The apparatus may include at least one memory storing code and one or more processors coupled with the at least one memory. The one or more processors may be individually or collectively operable to execute the code to cause the apparatus to: receive a request to terminate a set of sessions between a user of an identity management system and a respective set of applications that are accessible via the identity management system, the request including information associated with the user, information associated with the set of sessions, or both; receive, via an endpoint associated with a tenant of the identity management system, a set of API credentials that are usable to communicate with the respective set of applications via a respective set of APIs; transmit, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof; and output, to an observability log maintained by the identity management system, metadata associated with a result of the ULO operation or the SLO operation.

A non-transitory computer-readable medium is described. The non-transitory computer-readable medium may store code that includes instructions executable by one or more processors to: receive a request to terminate a set of sessions between a user of an identity management system and a respective set of applications that are accessible via the identity management system, the request including information associated with the user, information associated with the set of sessions, or both; receive, via an endpoint associated with a tenant of the identity management system, a set of API credentials that are usable to communicate with the respective set of applications via a respective set of APIs; transmit, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof; and output, to an observability log maintained by the identity management system, metadata associated with a result of the ULO operation or the SLO operation.

In some examples described herein, the request includes an identifier of the user, an identifier of at least one session of the set of sessions, one or more options for the ULO operation or the SLO operation, or any combination thereof.

In some examples described herein, the user may be associated with the tenant of the identity management system.

In some examples described herein, at least one of the respective set of applications includes a third-party application.

In some examples described herein, the request may be initiated by an administrative user associated with the tenant of the identity management system.

In some examples described herein, the request may be triggered by a risk metric exceeding a threshold for the user.

In some examples described herein, the SLO operation includes logging the user out of a specific session between the user and an application or logging the user out of all sessions between the user and the application.

In some examples described herein, at least one of the set of sessions may be terminated using Security Assertion Markup Language (SAML) 2.0, OpenID Connect (OIDC), System for Cross-domain Identity Management (SCIM), or any combination thereof.

### BRIEF DESCRIPTION OF THE DRAWINGS

FIGS. 1 through 3 illustrate examples of computing systems that support universal logout (ULO) and single logout (SLO) techniques in accordance with aspects of the present disclosure.

FIGS. 4 and 5 illustrate examples of flowcharts that support ULO and SLO techniques in accordance with aspects of the present disclosure.

FIG. 6 shows a block diagram of an apparatus that supports ULO and SLO techniques in accordance with aspects of the present disclosure.

FIG. 7 shows a block diagram of a ULO/SLO manager that supports ULO and SLO techniques in accordance with aspects of the present disclosure.

FIG. 8 shows a diagram of a system including a device that supports ULO and SLO techniques in accordance with aspects of the present disclosure.

FIG. 9 shows a flowchart illustrating methods that support ULO and SLO techniques in accordance with aspects of the present disclosure.

### DETAILED DESCRIPTION

An identity management platform may support various authentication and authorization services, including single sign-on (SSO), Security Assertion Markup Language (SAML) 2.0, OpenID Connect (OIDC), and System for Cross-domain Identity Management (SCIM), among other examples. Some clients of the identity management system may desire additional application capabilities to support different security outcomes a client may use in various circumstances. For example, some clients may want the capability to log a user out of third-party applications for which the identity management system operates as an IDP. Third-party applications may support a range of mechanisms for initiating logout, from standards-based approaches like Front Channel SAML, to Back Channel OIDC single logout (SLO), to proprietary endpoints that trigger the removal of one or all of a user's sessions. For applications that do not support standards-based logout mechanisms, however, the identity management system may call specific APIs for specific applications to trigger a logout.

Aspects of the present disclosure generally support SLO and universal logout (ULO) mechanisms for third-party applications with heterogenous logout capabilities. In accordance with the techniques described herein, the identity management system may receive a request to terminate multiple (e.g., two or more) sessions between a user of an identity management system and multiple applications that are accessible via the identity management system. The request may include information associated with the user (such as an identifier of the user), information associated with the sessions (such as a session identifier), and other SLO/ULO parameters. In some implementations, the request may be triggered or otherwise initiated by a user with administrative privileges. In other implementations, the request may be triggered/initiated in response to a detected/predicted risk level of the user exceeding a threshold.

After receiving the request, the identity management system may obtain a set of application programming interface (API) credentials via an endpoint associated with a tenant (e.g., client) of the identity management system. The set of API credentials may enable the identity management system to interact with the target applications via respective APIs. Accordingly, the identity management system may transmit respective API calls to the target applications using the API credentials obtained from the client/tenant endpoint. The respective API calls may include some or all of the information provided with the original request, and may cause the target applications to terminate the requested sessions according to the specified SLO/ULO parameters. In turn, the identity management system may write SLO/ULO metadata (such as whether the federated logout attempt was successful) to an observability log, such that administrative users can check on the status of the requested SLO/ULO operation.

Aspects of the disclosure are initially described in the context of computing systems and flowcharts. Aspects of the disclosure are further illustrated by and described with reference to apparatus diagrams, system diagrams, and flowcharts that relate to ULO and SLO techniques.

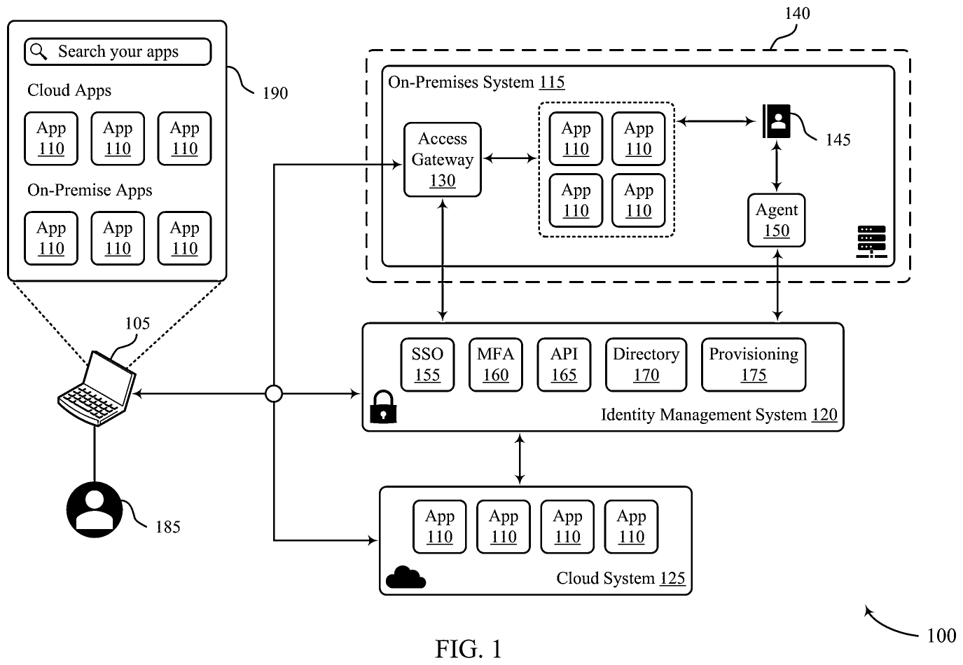

FIG. 1 illustrates an example of a computing system 100 that supports ULO and SLO techniques in accordance with various aspects of the present disclosure. The computing system 100 includes a client device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the client device 105 to communicate with one or more of the on-premises system 115, the identity management system 120, or the cloud system 125. For example, the user 185 may access one or more applications 110 by interacting with an interface 190 of the client device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the client device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the client device 105 (e.g., the browser or application 110 running on the client device 105). In some examples, the application 110 may be associated with a service provider (SP), which may host or manage the application 110. In such examples, the client device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

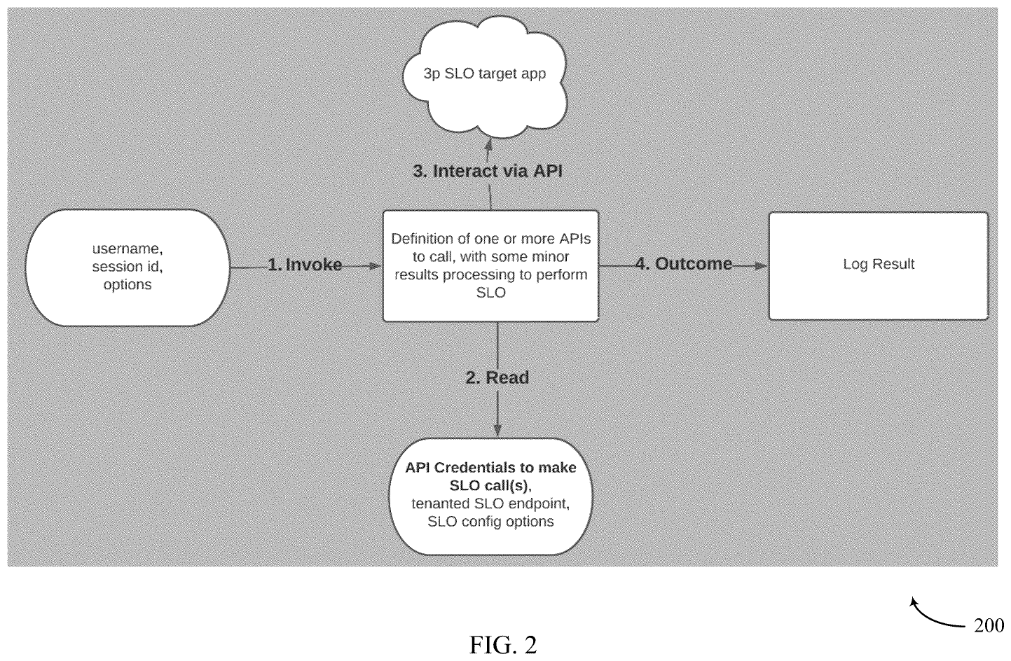

FIG. 2 shows an example of a computing system 200 that supports ULO and SLO techniques in accordance with aspects of the present disclosure. The computing system 200 may implement one or more aspects of the computing system 100, as shown and described with reference to FIG. 1. For example, one or more aspects of the computing system 200 may be implemented (at least in part) by the identity management system 120 described with reference to FIG. 1. The computing system 200 illustrates an example of a federated logout scheme, whereby the identity management system 120 can terminate multiple sessions between a user 185 and one or more applications 110.

As described herein, SLO refers to a process where a user 185 is logged out of multiple applications 110 without individually logging out of them. SLO generally refers to using a standards-based mechanisms to initiate a federated logout. For example, an IDP may request for a user's session to end at the SP. ULO, on the other hand, may include two different use cases. In some examples, ULO may refer to logging the user 185 out of the identity management system 120 (e.g., IdP) and making a federated request to log the user 185 out of all third-party applications 110 that were actively associated with the user's session. In other examples, ULO may refer to logging the user 185 out of all sessions they currently have with a given third-party application 110, including web/device sessions. That is, SLO=sessionLogout (e.g., end a web session) and ULO=revokeAll (e.g., end all the web, mobile sessions and revoke tokens where possible).

In some implementations, standards-based SLO may support the capability to end all of a user's sessions for a given third-party application 110, when used in specific configurations. For example, the OIDC backchannel SLO specification indicates that a logout token can either specify a subject (e.g., the user 185) or a session ID. When the caller (e.g., the identity management system 120) provides a subject, the semantic intent is to end all the sessions between that user 185 and the third-party application 110. This functionality overlaps with some implementations of ULO. Third-party applications 110 may support one, both, or neither of the SLO and ULO mechanisms described herein. As with other applications 110 that support SCIM, SAML, and/or OIDC, the identity management system 120 may surface these capabilities to clients so they are aware of which options are supported/available.

Aspects of the present disclosure generally support techniques for integrating SLO/ULO capabilities with other services and capabilities of the identity management system 120. In the example of FIG. 2, a set of parameters may be passed to the identity management system 120. The parameters may include a user ID, session ID, and other SLO/ULO options. Accordingly, the identity management system 120 may read (e.g., retrieve, obtain) credentials or a configuration managed by a client organization that has permission to invoke session revocation and/or SLO APIs. Thereafter, the identity management system 120 may use one or more API clients to invoke external APIs, using the credentials provided and the set of parameters as payload/URI options. The identity management system 120 may log the outcome in a uniform manner (from an observability standpoint), so clients can see the outcome of the attempted logout operation. This can be beneficial for third-party applications, as the identity management system 120 may sometimes be unable to ensure that the logout is successfully executed.

The described techniques may support RP/SP-initiated (e.g., application-initiated) front channel logout for both OIDC and SAML 2.0 as a trigger mechanism, as well as front channel logout for both OIDC and SAML 2.0 to downstream applications. The identity management system 120 may support front channel IdP-initiated logout (as a result of the initial application-initiated logout request being made) and front channel logouts for downstream applications. As an example, a user 185 may log out of an application 110 using a browser 505, meaning a request is sent from the application 110 to the identity management system 120 via the browser 505. The identity management system 120 may identity which other applications 110 the user 185 is logged into in a given session, and send a logout request to these applications before terminating the session and returning to the application 110. As the other applications 110 have sessions for the user 185 in other browsers 505 (and on other client devices 105), these sessions may also be terminated.

In some implementations, the user 185 may not be logged out of certain applications 110, and the user 185 may still have an active session in another browser 505. The user 185 may be logged out of a particular application on multiple browsers running on the same client device 105. The user 185 may be logged out of an application 110 on one browser and on other client devices 105 using a browser 505 and a non-browser application. Some sessions between the user 185 and the identity management system 120 may be terminated, while others may be active (despite the fact that some application 110 no longer have an valid session in certain browsers 505).

In some examples, to support SAML-based SLO, a new parameter (“particpateSlo”) may be added to the response under json.settings.signOn. This parameter may include one or more of the following fields: participateSlo.enabled: Admin to opt for Single Logout Service in SAML 2.0 apps; participateSlo.logoutRequestURL: Once logout is performed at IdP, SP provides this URL for IdP to send a <LogoutRequest> to SP; participateSlo.sessionIndexRequired (optional, defaults to false): Admin should opt this for IDP to send <samlp: SessionIndex> in the logout request; participateSlo.bindingType (optional, defaults to REDIRECT): bindingType for LogoutRequests that are sent to SP. Values: POST/REDIRECT.

The participateSlo attribute/parameter may be independent of the sloEnabled flag; spCertificate, logoutRequestURL, and sessionIndexRequired may be dependent on participateSlo to be true. These fields may be persisted under saml20ParticipateSlo, saml20LogoutRequestURL, saml20SessionIndexRequired, and saml20SloBinding columns within the ConfiguredSignOnModes table. A new endpoint may also be added for SAML applications to send their LogoutResponse to the identity management system 120. This endpoint may be published in metadata under the SingleLogoutService ResponseLocation attribute.

The SLO API configuration for OIDC applications may include one or more of the following fields: participate_slo: /applications only, false for non-web/SPA applications; frontchannel_logout_uri: /applications and /clients, surfaced when participate_slo is true; frontchannel_logout_session_required: /applications and /clients, surfaced when participate_slo is true; these fields may be persisted under participateSlo, frontChannelLogoutUri, and frontChannelLogoutSessionRequired columns in the PublicClientApp table.

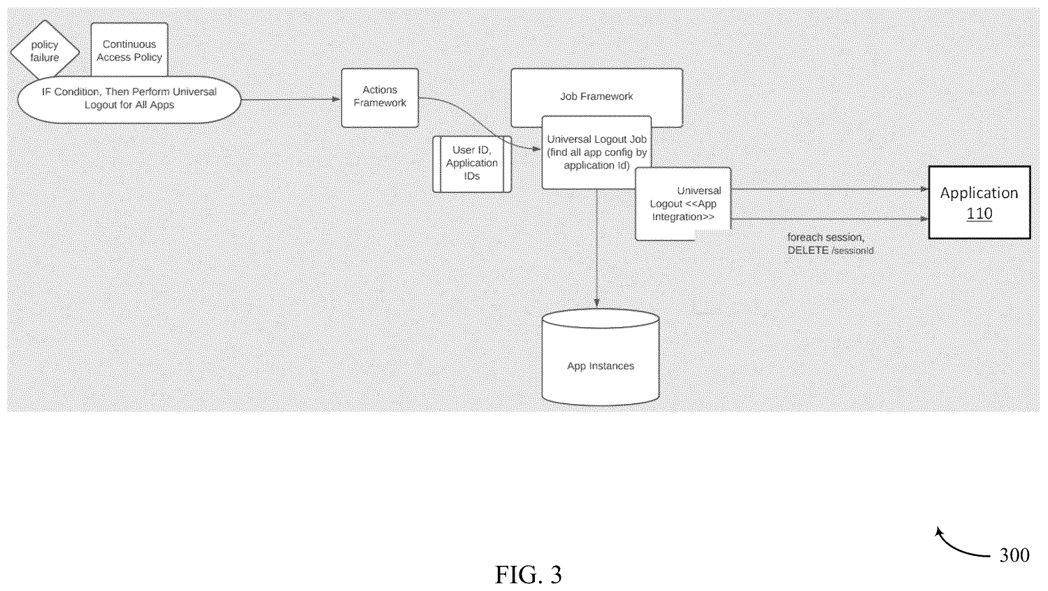

FIG. 3 shows an example of a computing system 300 that supports ULO and SLO techniques in accordance with aspects of the present disclosure. The computing system 300 may implement one or more aspects of the computing system 100 or the computing system 200, as shown and described with reference to FIGS. 1 and 2. For example, one or more aspects of the computing system 300 may be implemented (at least in part) by the identity management system 120 described with reference to FIG. 1. The computing system 300 illustrates an example of a federated logout scheme, whereby the identity management system 120 can effectively terminate multiple sessions between a user 185 and one or more applications 110. In the example of FIG. 3, an identity network platform of the identity management system 120 may provide an SLO/ULO configuration, and a client organization may handle the run-time and/or control plane operations associated with performing a federated logout action.

In some implementations, clients of the identity management system 120 may want the capability to configure the identity management system 120 so that when high risk activity is detected for a given session (or a given account), the client organization can decide that an appropriate remediation would be to actively log the user 185 out of all third-party applications currently accessible to the user 185. The techniques described herein generally provide for extending the architecture of the identity management system 120 to support ULO/SLO capabilities. To provide the logout capabilities described herein, the identity management system 120 may use custom API calls and/or support adoption of other standards-based approaches. To improve user experience, the SAML ACS URL for a target application 110 may be co-located with (e.g., positioned near) an SLO URL endpoint, and the configuration of trusted key-pairs for SSO may be co-located with (or re-used for) SLO.

Third-party application logout and ULO can be triggered in a number of different ways. Clients may want an administrative control that enables them to invoke existing session API(s) and pass a flag to indicate that all third-party application sessions are to be terminated for a given user 185. Other scenarios may include taking remediation actions (in response to a detected/predicted risk level) configured by the tenant organization. Other use cases may involve an end-user triggering a logout via a front channel-initiated logout and/or back channel calls to provide more extensive coverage (such as for a shared kiosk model where the user 185 wants to ensure they have logged out of all applications 110). The implementation of SLO/ULO actions does not pre-suppose a relationship to one stock keeping unit (SKU) or flow, and may support other integrations with other applications 110.

In some implementations, the identity management system 120 may deliver SLO using existing connectors, or by creating new connectors to establish API access to target applications 110. In some examples, client organizations may configure each application connector with appropriate credentials to facilitate interactions with SLO APIs. The identity management system 120 may deliver templates (per application 110) that implement ULO/SLO capabilities, depending on the target application 110. Each template may be relatively small, as the logout mechanism for a given third-party application 110 may involve relatively few APIs, with a relatively low degree of processing or transformation between operations. A step may be added to each flow to log the outcome of the SLO operation back to a system logging service of the identity management system 120 (syslog), thereby providing clients with end-to-end observability of the outcome of SLO API call(s).

In other implementations, the identity management system 120 may deliver SLO via an integration network platform. To do so, the identity management system 120 may add new capabilities to applications 110 to support SLO/ULO for either logging out of a given session instance or all sessions for a given application 110 (depending on what standards or proprietary functions are supported). These capabilities may be added to other capabilities currently supported by other applications 110 within the identity network platform. This approach may offer the following technical benefits: administrative experience puts SSO and SLO configurations in a uniform control plane; re-use existing credentials for SLO operations; quickly patch and do versioned releases of changes to supported applications; no customer interaction required to download, install or re-install connectors; migrate from proprietary to standards-based implementations over time as third-party applications add support; push updates seamlessly to clients; easily incorporate logging and observability in the control flow where the operation was invoked; uniformly support both proprietary SLO implementations and standards-based implementations within the integration network platform.

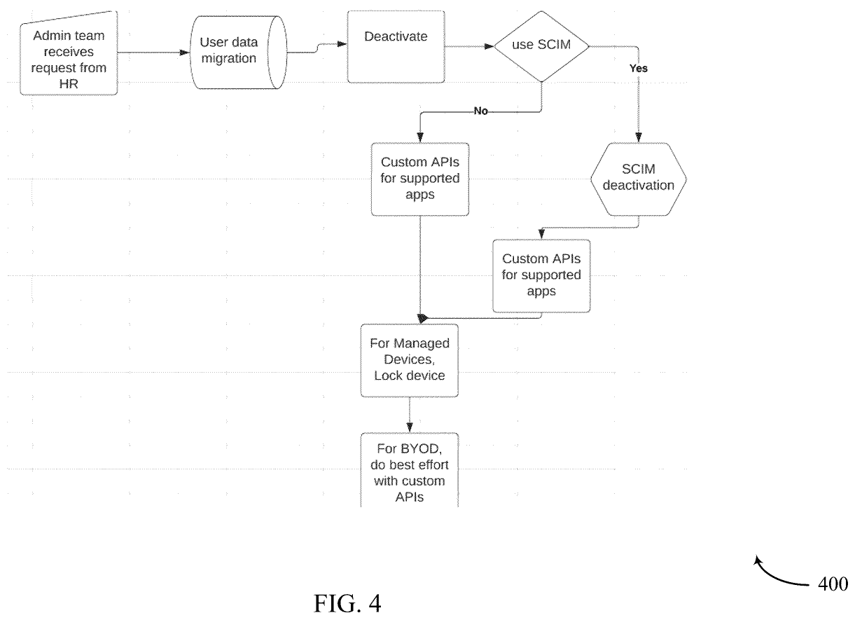

FIG. 4 shows an example of a flowchart 400 that supports ULO and SLO techniques in accordance with aspects of the present disclosure. The flowchart 400 may implement one or more aspects of the computing system 100 or the computing system 200, as shown and described with reference to FIGS. 1 and 2. For example, one or more operations of the flowchart 400 may be implemented (at least in part) by the identity management system 120, as shown and described with reference to FIG. 1. The flowchart 400 illustrates an example of a federated logout scheme, whereby the identity management system 120 can terminate multiple sessions between a user 185 and one or more applications 110 that use the identity management system 120 as an IdP.

Aspects of the present disclosure generally provide for enabling an administrative user of the identity management system 120 to terminate all sessions across all client devices 105 of a user 185 (or users 185). As described herein, “all sessions” may include a user's IdP session, web application sessions, native application sessions (phone/tablet), native applications (desktop), or any combination thereof. Long-lived application sessions are preferred in some cases because they offer improved user experience. However, long-lived application sessions may present security risks, especially if these applications 110 contain sensitive data. Once a user 185 is authenticated with the identity management system 120, the 185 may be redirected back to the applications 110, where the applications 110 provides an access token to the user. In some cases, however, these access tokens may have a relatively long time-to-live, anywhere from an hour to a full working day, a week, a quarter, or an indefinite amount of time. If, for example, there is a change in user behavior, or if the user is no longer a part of the organization, the identity management system 120 may be unable to intercept and terminate all of the application sessions that were established via the identity management system 120. As such, client organizations may be vulnerable to security threats, data exposure, etc.

The operations depicted in the example of FIG. 4 illustrate the process of manually revoking a user's access to client applications upon immediate termination. First, the HR system may notify the team that manages usage of the identity management system 120. Next, an administrative user may take an action on data transfers (as needed) and deactivate the user's account. If SCIM is supported, SCIM deactivation may then commence. In some cases, this may terminate existing application sessions if the application supports SCIM deletion and session revocation. If SCIM is unsupported, the administrative user may have to manually deactivate the user's licenses and corresponding applications 110. This may involve terminating active sessions with applications through a number of custom APIs. Next, the client may lock the user's devices (if managed). If the device belongs to the user 185, the client may leave active application sessions and allow them to expire (as there is no integration to terminate all sessions).

For security-centric use cases, the client/tenant security team may determine that the user is at risk, using in-house tools or user-reported suspicious activity. The security team may reach out to an administrator of the identity management system 120 to clear the user's access tokens. The administrator of the identity management system 120 may then clear all of the user's sessions and access/refresh tokens previously issued to the user 185.

The techniques described herein can be used for a wide variety of implementations, such as employee termination and security risk mitigation. For example, the SLO/ULO techniques described herein can be used for immediate termination (such as layoffs, HR purposes, legal reasons) and termination upon mutual agreement. Additionally, or alternatively, the described techniques can be used if the user risk is high and an administrative user has configured the identity management system 120 to terminate all sessions based on a continuous access evaluation session policy and/or a user risk policy. If a user 185 reports a lost or stolen device, the administrative user can also terminate all active sessions on the device and/or lock the device (if managed) to keep all data secure.

If a user is identified as a bad actor (e.g., an inside threat) by security personnel of the identity management system 120 (e.g., based on suspicious activity), the administrative user can terminate all sessions across all devices for the user 185. If the user's credentials are compromised, the administrative user can trigger universal application logout. In some examples, if the user is under investigation, the client may want to suspend the user 185 and terminate all active sessions across all devices.

User-initiated SLO enables users to log out of all their applications 110 with a single action, rather than having to log out of each application 110 separately. The main differences between universal application logout and SLO is that user initiated SLO is driven by the end-user. Admin-initiated SLO is where an administrator can logout of all the user's sessions with a single action (via a back channel). To trigger admin-initiated SLO, the application 110 has to support one of the protocols (SAML, OIDC). For universal application logout, the application 110 can also leverage other custom APIs/methods. Also, SAML back channel logout can only terminate web application sessions, whereas universal application logout may have to terminate all sessions. For OIDC back channel logout, developers may have to implement or support global logout so the application 110 can clear all sessions (as described herein).

Without the techniques described herein, a combination of manual processes, SCIM deprovisioning techniques, and custom tools/APIs may be needed for multi-session termination. These manual processes may be time-consuming and manually intensive. Further, even with such mechanisms, clients are still unable to terminate all of a user's sessions (and are left to other best-effort solutions). Additionally, these mechanisms offer no way to track or report the status or progress of a federated logout operation. For example, clients may be unaware of: how many applications were revoked; how many logout operations failed; how many applications lack a method for token revocation; and how many times the logout operation was invoked in a given time period (e.g., the last X days). For security-centric implementations, clients may also be unable to terminate all of a user's sessions without deactivating/deprovisioning the user 185. Hence, clients may have to suspend the user 185 and leave existing sessions in their current state (with the hope that a session timeout will occur). However, some clients may not want to deactivate or deprovision users in some circumstances.

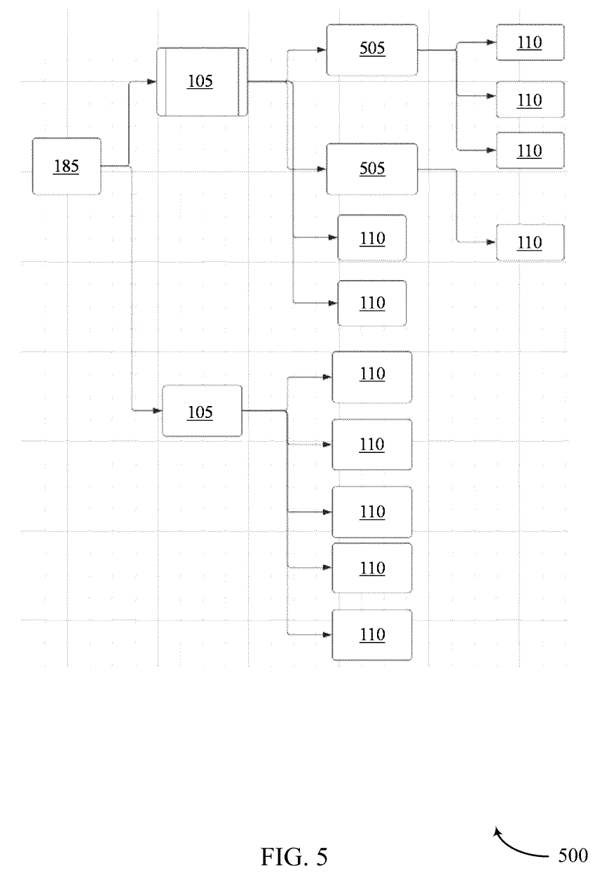

FIG. 5 shows an example of a flowchart 500 that supports ULO and SLO techniques in accordance with aspects of the present disclosure. The flowchart 500 may implement one or more aspects of the computing system 100 or the computing system 200, as shown and described with reference to FIGS. 1 and 2. For example, one or more operations of the flowchart 500 may be implemented (at least in part) by the identity management system 120, as shown and described with reference to FIG. 1. The flowchart 500 illustrates an example of a federated logout scheme, whereby the identity management system 120 can terminate multiple sessions between a user 185 and one or more applications 110 that use the identity management system 120 as an IdP.

The techniques described herein may enable an administrator of the identity management system 120 to configure application ULO. To do so, the administrator may enable API login and grant scopes for the applications 110. The administrator may then be able to configure one or more of the following actions for the applications 110: sign out of all the sessions of a user 185; sign the user 185 out of a particular application 110; revoke a refresh token for the application 110. When the session context changes and the global sign-on policy is re-evaluated: if access is set to Allowed and MFA is set to not required, the session may remain untouched and continue to be active. If access is set to be denied based on the policy re-evaluation result: the corresponding IdP session may be revoked; and corresponding application sessions may be revoked based on the configuration set by the administrator on the access policy setting. If access is allowed and the MFA is set to required based on the policy re-evaluation: the corresponding IdP session may be revoked and the user 185 may have to login with MFA to continue the session.

When the session context changes and the authentication sign-on policy is re-evaluated: if the access is set to Allowed after successful authentication and the assurance is met, the session remains untouched and continues to be active; if the access is set to be Denied based on the policy re-evaluation result and the policy pertains to an application 110 that has been configured to sign out (a particular application sign out is supported), the corresponding application session is signed out. If the policy pertains to an application 110 that has been configured to sign out of all the sessions of this application 110 for this user 185, all the corresponding sessions of this application 110 across all client devices 105 for a user 185 may be signed out. If the policy pertains to an application 110 that has been configured to revoke refresh tokens, the corresponding application's refresh token is revoked, and the current session remains valid.

When user risk changes (as configured in the entity risk policy) and the entity risk policy is re-evaluated: if the user risk changes to High, the administrator may configure universal application logout, which can do the following: terminate all sessions across all client devices 105 of this user 185. The administrator can also revoke all sessions (IdP and applications) across all devices for a suspended user. As part of the suspend operation, the administrator may be provided with an option (e.g., a checkbox) to revoke all IdP and application sessions across all client devices 105 for a user 185. When the check box is enabled and the administrator suspends a user 185, all active sessions for the user 185 may be revoked. As part of the API call, this may include an option to terminate all sessions. By default, this option can be false or unchecked. Additionally, syslog event(s) may be generated with the corresponding information: timestamp; which applications were revoked; which applications could not be revoked (in case of errors); user details; and the reason for logout (e.g., which operation triggered this action).

Administrative users of the identity management system 120 may also be able to revoke all the sessions (IdP and application) across all client devices 105 of a deactivated user. As part of the deactivate operation, all the IdP and application sessions across all client devices 105 of the user 185 may be revoked. Additionally, syslog event(s) may be generated with the corresponding information: timestamp; which applications were revoked; which applications could not be revoked (in case of errors); user details; and the logout reason (e.g., which operation triggered this action). In some implementations, an administrator of the identity management system 120 may also be able to revoke all sessions (IdP and application) across all client devices 105 of a user 185 by interacting with a “Clear User sessions” button for the user 185. As part of the clear user sessions operation, the administrative user may be provided with an option (e.g., a checkbox) to revoke all IdP and application sessions across all client devices 105 for a user 185. When the checkbox is enabled and the administrator clicks clear user sessions for a user 185, all active sessions for the user 185 may be revoked. As part of the API call, this may have an option to terminate all sessions. By default, this option can be false or unchecked. Additionally, syslog event(s) may be generated with the corresponding information: timestamp; which applications were revoked; which applications could not be revoked (in case of errors); user details; and the reason for logout (e.g., which operation triggered this action).

Administrative users of the identity management system 120 may also be able to: terminate all active sessions (IdP, web application, native application) of a user 185 (across all client devices 105) as part of the termination/offboarding process; deactivate a user 185 (which may terminate all of the user's sessions); configure an action to terminate all active sessions of a user 185 when user risk is high (as part of user risk policy); configure an action to terminate all active sessions of a user 185 upon request from the security team, when a user 185 reports suspicious activity, or when the user 185 reports stolen device or lost device; and view a report that tells the administrator which applications were terminated (and which were not) as part of the universal application logout process, such that the administrator can use this information for reporting and other termination processes.

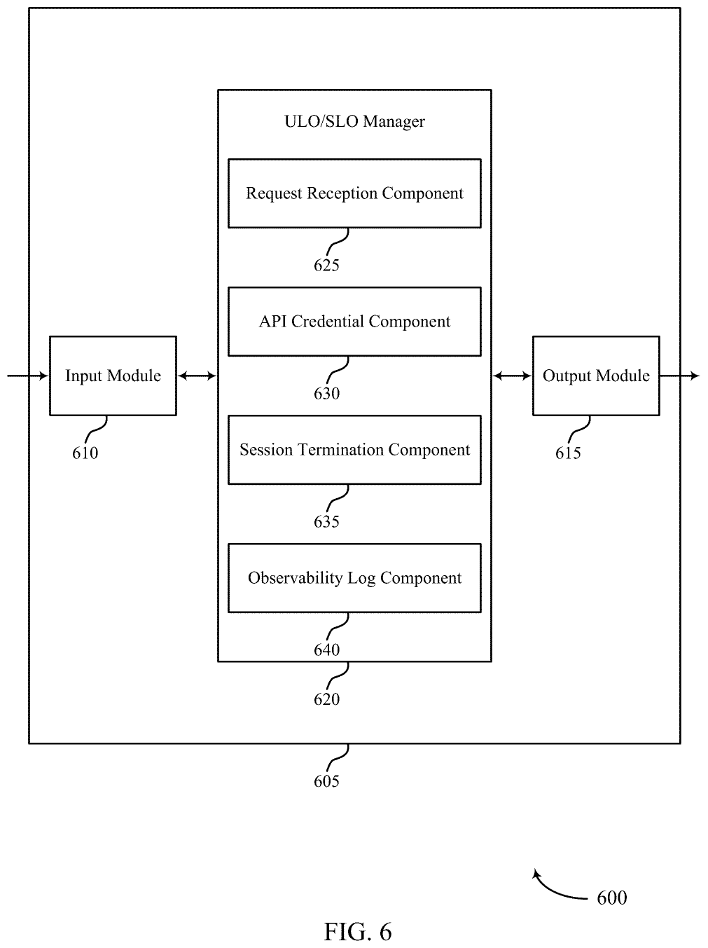

FIG. 6 shows a block diagram 600 of a device 605 associated with an identity management system that supports ULO and SLO techniques in accordance with aspects of the present disclosure. The device 605 may include an input module 610, an output module 615, and a ULO/SLO manager 620. The device 605, or one of more components of the device 605 (e.g., the input module 610, the output module 615, and the ULO/SLO manager 620), may include at least one processor, which may be coupled with at least one memory, to support the described techniques. Each of these components may be in communication with one another (e.g., via one or more buses).

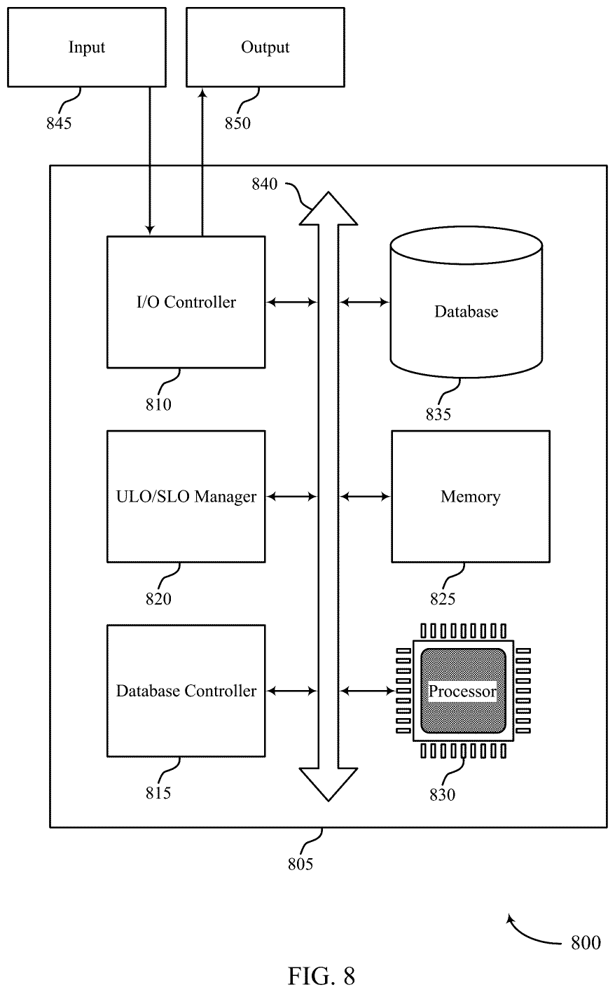

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the ULO/SLO manager 620 to support ULO and SLO techniques. In some cases, the input module 610 may be a component of an input/output (I/O) controller 810, as described with reference to FIG. 8.

The output module 615 may manage output signals for the device 605. For example, the output module 615 may receive signals from other components of the device 605, such as the ULO/SLO manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810, as described with reference to FIG. 8.

For example, the ULO/SLO manager 620 may include a request reception component 625, an API credential component 630, a session termination component 635, an observability log component 640, or any combination thereof. In some examples, the ULO/SLO manager 620, or various components thereof, may be configured to perform various operations (e.g., receiving, monitoring, transmitting) using or otherwise in cooperation with the input module 610, the output module 615, or both. For example, the ULO/SLO manager 620 may receive information from the input module 610, send information to the output module 615, or be integrated in combination with the input module 610, the output module 615, or both to receive information, transmit information, or perform various other operations as described herein.

The request reception component 625 may be configured to or otherwise capable of receiving a request to terminate a set of sessions between a user of an identity management system and a respective set of applications that are accessible via the identity management system, the request including information associated with the user, information associated with the set of sessions, or both. The API credential component 630 may be configured to or otherwise capable of receiving, via an endpoint associated with a tenant of the identity management system, a set of API credentials that are usable to communicate with the respective set of applications via a respective set of APIs. The session termination component 635 may be configured to or otherwise capable of transmitting, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof. The observability log component 640 may be configured to or otherwise capable of outputting, to an observability log maintained by the identity management system, metadata associated with a result of the ULO operation or the SLO operation.

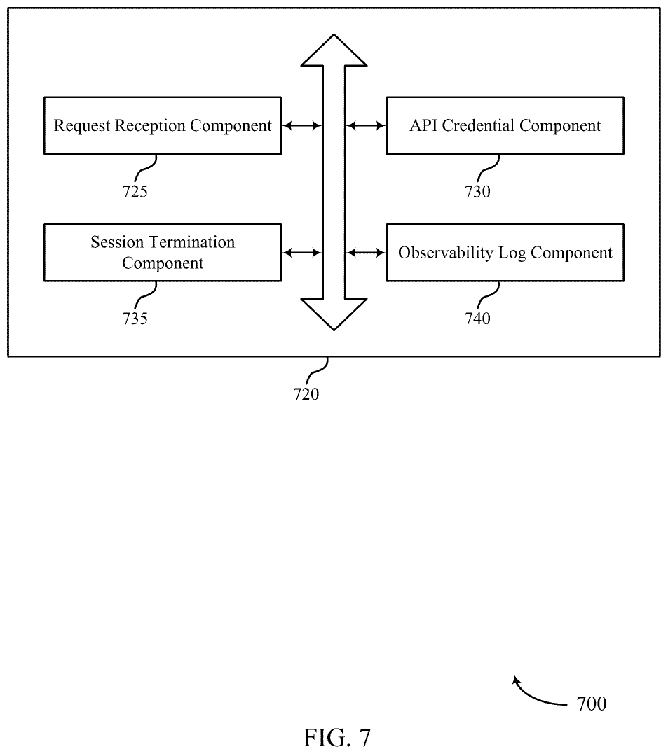

FIG. 7 shows a block diagram 700 of a ULO/SLO manager 720 that supports ULO and SLO techniques in accordance with aspects of the present disclosure. The ULO/SLO manager 720 may be an example of aspects of a ULO/SLO manager 620, as described herein. The ULO/SLO manager 720, or various components thereof, may be an example of means for performing various aspects of ULO and SLO techniques as described herein. For example, the ULO/SLO manager 720 may include a request reception component 725, an API credential component 730, a session termination component 735, an observability log component 740, or any combination thereof. Each of these components, or components of subcomponents thereof (e.g., one or more processors, one or more memories), may communicate, directly or indirectly, with one another (e.g., via one or more buses).

The request reception component 725 may be configured to or otherwise capable of receiving a request to terminate a set of sessions between a user of an identity management system and a respective set of applications that are accessible via the identity management system, the request including information associated with the user, information associated with the set of sessions, or both. The API credential component 730 may be configured to or otherwise capable of receiving, via an endpoint associated with a tenant of the identity management system, a set of API credentials that are usable to communicate with the respective set of applications via a respective set of APIs. The session termination component 735 may be configured to or otherwise capable of transmitting, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof. The observability log component 740 may be configured to or otherwise capable of outputting, to an observability log maintained by the identity management system, metadata associated with a result of the ULO operation or the SLO operation.

In some examples, the request includes an identifier of the user, an identifier of at least one session of the set of sessions, one or more options for the ULO operation or the SLO operation, or any combination thereof.

In some examples, the user is associated with the tenant of the identity management system. In some examples, at least one of the respective set of applications includes a third-party application.

In some examples, the request is initiated by an administrative user associated with the tenant of the identity management system. In some examples, the request is triggered by a risk metric exceeding a threshold for the user.

In some examples, the SLO operation includes logging the user out of a specific session between the user and an application or logging the user out of all sessions between the user and the application.

In some examples, at least one of the set of sessions is terminated using SAML 2.0, OIDC, SCIM, or any combination thereof.

FIG. 8 shows a diagram of a system 800 (such as an identity management system 120), including a device 805 that supports ULO and SLO techniques in accordance with aspects of the present disclosure. The device 805 may be an example of or include the components of a device 605, as described herein. The device 805 may include components for bi-directional voice and data communications including components for transmitting and receiving communications, such as a ULO/SLO manager 820, an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting ULO and SLO techniques). The processor 830 may be an example of a single processor or multiple processors. For example, the device 805 may include one or more processors 830.

In accordance with aspects of the present disclosure, the ULO/SLO manager 820 may be configured to or otherwise capable of receiving a request to terminate a set of sessions between a user of an identity management system and a respective set of applications that are accessible via the identity management system, the request including information associated with the user, information associated with the set of sessions, or both. The ULO/SLO manager 820 may be configured to or otherwise capable of receiving, via an endpoint associated with a tenant of the identity management system, a set of API credentials that are usable to communicate with the respective set of applications via a respective set of APIs. The ULO/SLO manager 820 may be configured to or otherwise capable of transmitting, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof. The ULO/SLO manager 820 may be configured to or otherwise capable of outputting, to an observability log generating by the identity management system, metadata associated with a result of the ULO operation or the SLO operation.

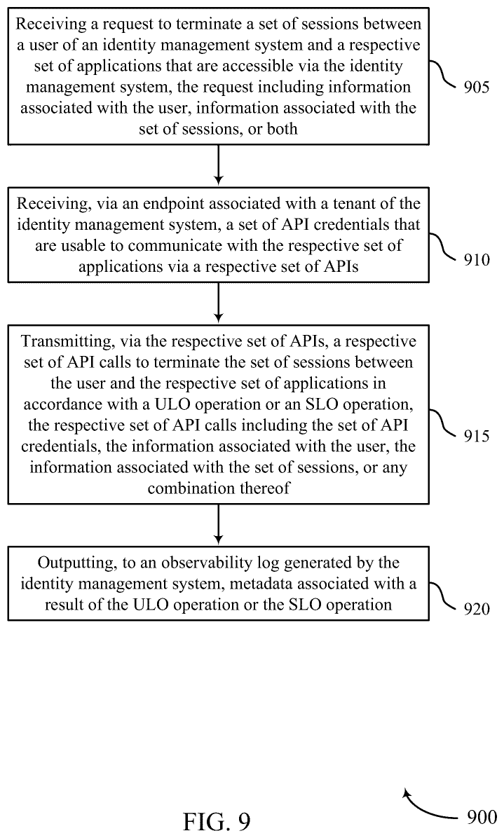

FIG. 9 shows a flowchart illustrating a method 900 that supports ULO and SLO techniques in accordance with aspects of the present disclosure. The operations of the method 900 may be implemented by an identity management system, such as the identity management system 120 described with reference to FIGS. 1 through 8. In some examples, the identity management system may execute a set of instructions to control the functional elements of the identity management system to perform the described functions. Additionally, or alternatively, the identity management system may perform aspects of the described functions using special-purpose hardware.

At 905, the method may include receiving a request to terminate a set of sessions between a user of an identity management system and a respective set of applications that are accessible via the identity management system, the request including information associated with the user, information associated with the set of sessions, or both. In some examples, aspects of the operations of 905 may be performed by a request reception component 725, as described with reference to FIG. 7.

At 910, the method may include receiving, via an endpoint associated with a tenant of the identity management system, a set of API credentials that are usable to communicate with the respective set of applications via a respective set of APIs. In some examples, aspects of the operations of 910 may be performed by an API credential component 730, as described with reference to FIG. 7.

At 915, the method may include transmitting, via the respective set of APIs, a respective set of API calls to terminate the set of sessions between the user and the respective set of applications in accordance with a ULO operation or an SLO operation, the respective set of API calls including the set of API credentials, the information associated with the user, the information associated with the set of sessions, or any combination thereof. In some examples, aspects of the operations of 915 may be performed by a session termination component 735, as described with reference to FIG. 7.

At 920, the method may include outputting, to an observability log maintained by the identity management system, metadata associated with a result of the ULO operation or the SLO operation. In some examples, aspects of the operations of 920 may be performed by an observability log component 740, as described with reference to FIG. 7.

The following provides an overview of aspects of the present disclosure:

Aspect 1: A method, comprising: receiving a request to terminate a plurality of sessions between a user of an identity management system and a respective plurality of applications that are accessible via the identity management system, the request comprising information associated with the user, information associated with the plurality of sessions, or both; receiving, via an endpoint associated with a tenant of the identity management system, a set of API credentials that are usable to communicate with the respective plurality of applications via a respective plurality of APIs; transmitting, via the respective plurality of APIs, a respective plurality of API calls to terminate the plurality of sessions between the user and the respective plurality of applications in accordance with a ULO operation or an SLO operation, the respective plurality of API calls including the set of API credentials, the information associated with the user, the information associated with the plurality of sessions, or any combination thereof; and outputting, to an observability log maintained by the identity management system, metadata associated with a result of the ULO operation or the SLO operation.

Aspect 2: The method of aspect 1, wherein the request comprises an identifier of the user, an identifier of at least one session of the plurality of sessions, one or more options for the ULO operation or the SLO operation, or any combination thereof.

Aspect 3: The method of any of aspects 1 through 2, wherein the user is associated with the tenant of the identity management system.

Aspect 4: The method of any of aspects 1 through 3, wherein at least one of the respective plurality of applications comprises a third-party application.

Aspect 5: The method of any of aspects 1 through 4, wherein the request is initiated by an administrative user associated with the tenant of the identity management system.

Aspect 6: The method of any of aspects 1 through 5, wherein the request is triggered by a risk metric exceeding a threshold for the user.

Aspect 7: The method of any of aspects 1 through 6, wherein the SLO operation comprises logging the user out of a specific session between the user and an application or logging the user out of all sessions between the user and the application.

Aspect 8: The method of any of aspects 1 through 7, wherein at least one of the plurality of sessions is terminated using SAML 2.0, OIDC, SCIM, or any combination thereof.

Aspect 9: An apparatus comprising: at least one memory storing code; and one or more processors coupled with the at least one memory, wherein the one or more processors are individually or collectively operable to execute the code to cause the apparatus to perform a method of any of aspects 1 through 8.

Aspect 10: An apparatus, comprising: at least one means for performing a method of any of aspects 1 through 8.

Aspect 11: A non-transitory computer-readable medium storing code that comprises instructions executable by one or more processors to perform a method of any of aspects 1 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
receiving a request to terminate a plurality of sessions between a user of an identity management system and a respective plurality of applications that are accessible via the identity management system, the request comprising information associated with the user, information associated with the plurality of sessions, or both;
receiving, via an endpoint associated with a tenant of the identity management system, a set of application programming interface (API) credentials that are usable to communicate with the respective plurality of applications via a respective plurality of APIs;
transmitting, via the respective plurality of APIs, a respective plurality of API calls to terminate the plurality of sessions between the user and the respective plurality of applications in accordance with a universal logout (ULO) operation or a single logout (SLO) operation, the respective plurality of API calls including the set of API credentials, the information associated with the user, the information associated with the plurality of sessions, or any combination thereof; and
outputting, to an observability log maintained by the identity management system, metadata associated with a result of the ULO operation or the SLO operation.

2. The method of claim 1, wherein the request comprises an identifier of the user, an identifier of at least one session of the plurality of sessions, one or more options for the ULO operation or the SLO operation, or any combination thereof.

3. The method of claim 1, wherein the user is associated with the tenant of the identity management system.

4. The method of claim 1, wherein at least one of the respective plurality of applications comprises a third-party application.

5. The method of claim 1, wherein the request is initiated by an administrative user associated with the tenant of the identity management system.

6. The method of claim 1, wherein the request is triggered by a risk metric exceeding a threshold for the user.

7. The method of claim 1, wherein the SLO operation comprises logging the user out of a specific session between the user and an application or logging the user out of all sessions between the user and the application.

8. The method of claim 1, wherein at least one of the plurality of sessions is terminated using Security Assertion Markup Language (SAML) 2.0, OpenID Connect (OIDC), System for Cross-domain Identity Management (SCIM), or any combination thereof.

9. An apparatus, comprising:
at least one memory storing code; and
one or more processors coupled with the at least one memory and individually or collectively operable to execute the code to cause the apparatus to:
receive a request to terminate a plurality of sessions between a user of an identity management system and a respective plurality of applications that are accessible via the identity management system, the request comprising information associated with the user, information associated with the plurality of sessions, or both;
receive, via an endpoint associated with a tenant of the identity management system, a set of application programming interface (API) credentials that are usable to communicate with the respective plurality of applications via a respective plurality of APIs;
transmit, via the respective plurality of APIs, a respective plurality of API calls to terminate the plurality of sessions between the user and the respective plurality of applications in accordance with a universal logout (ULO) operation or a single logout (SLO) operation, the respective plurality of API calls including the set of API credentials, the information associated with the user, the information associated with the plurality of sessions, or any combination thereof; and
output, to an observability log maintained by the identity management system, metadata associated with a result of the ULO operation or the SLO operation.

10. The apparatus of claim 9, wherein the request comprises an identifier of the user, an identifier of at least one session of the plurality of sessions, one or more options for the ULO operation or the SLO operation, or any combination thereof.

11. The apparatus of claim 9, wherein the user is associated with the tenant of the identity management system.

12. The apparatus of claim 9, wherein at least one of the respective plurality of applications comprises a third-party application.

13. The apparatus of claim 9, wherein the request is initiated by an administrative user associated with the tenant of the identity management system.

14. The apparatus of claim 9, wherein the request is triggered by a risk metric exceeding a threshold for the user.

15. The apparatus of claim 9, wherein the SLO operation comprises logging the user out of a specific session between the user and an application or logging the user out of all sessions between the user and the application.

16. The apparatus of claim 9, wherein at least one of the plurality of sessions is terminated using Security Assertion Markup Language (SAML) 2.0, OpenID Connect (OIDC), System for Cross-domain Identity Management (SCIM), or any combination thereof.

17. A non-transitory computer-readable medium storing code that comprises instructions executable by one or more processors to:
receive a request to terminate a plurality of sessions between a user of an identity management system and a respective plurality of applications that are accessible via the identity management system, the request comprising information associated with the user, information associated with the plurality of sessions, or both;
receive, via an endpoint associated with a tenant of the identity management system, a set of application programming interface (API) credentials that are usable to communicate with the respective plurality of applications via a respective plurality of APIs;
transmit, via the respective plurality of APIs, a respective plurality of API calls to terminate the plurality of sessions between the user and the respective plurality of applications in accordance with a universal logout (ULO) operation or a single logout (SLO) operation, the respective plurality of API calls including the set of API credentials, the information associated with the user, the information associated with the plurality of sessions, or any combination thereof; and
output, to an observability log maintained by the identity management system, metadata associated with a result of the ULO operation or the SLO operation.

18. The non-transitory computer-readable medium of claim 17, wherein the request comprises an identifier of the user, an identifier of at least one session of the plurality of sessions, one or more options for the ULO operation or the SLO operation, or any combination thereof.

19. The non-transitory computer-readable medium of claim 17, wherein the user is associated with the tenant of the identity management system.

20. The non-transitory computer-readable medium of claim 17, wherein at least one of the respective plurality of applications comprises a third-party application.
